(19) United States
(12) Patent Application Publication
(10) Pub. No.: US 2021/0282584 A1
(43) Pub. Date: Sep. 16, 2021

(54) APPARATUS FOR PREPARING A BEVERAGE

(71) Applicant: Conopco, Inc., d/b/a UNILEVER, Englewood, NJ (US)

(72) Inventors: Roberto DE MARTIS, Heerbrugg (CH); Patrik NAEFF, Heerbrugg (CH); Richard Heinz PODUSEL, Heerbrugg (CH)

(21) Appl. No.: 16/321,579

(22) PCT Filed: Jul. 20, 2017
(86) PCT No.: PCT/EP2017/068331

§ 371 Date: Jan. 29, 2019

(30) Foreign Application Priority Data
Aug. 11, 2016 (EP) 16183744.8

(51) Int. Cl. A47J 31/18; A47J 31/40

(52) U.S. Cl. CPC A47J 31/18; A47J 31/407

(57) ABSTRACT

An apparatus for preparing a beverage from a capsule containing particulate beverage precursor material includes a capsule reception location, a beverage infusion chamber, an infusion liquid supply, an infusion liquid flow path, a channel, and a transport device. The capsule reception location is configured to receive the capsule. The beverage infusion chamber has a chamber inlet for receiving infusion liquid and a chamber outlet comprising a filter for delivering a brewed beverage. The infusion liquid supply is configured to store the infusion liquid. The infusion liquid flow path connects the infusion liquid supply to the chamber inlet of the beverage infusion chamber. The channel connects the capsule reception location and the beverage infusion chamber. The transport device is configured to transport the particulate beverage precursor material from the capsule along the channel and to the beverage infusion chamber. The capsule reception location is remote from the infusion liquid flow path.

### TECHNICAL FIELD

The invention relates to an apparatus for preparing a beverage from a capsule comprising particulate beverage precursor material.

### BACKGROUND AND PRIOR ART

Many different designs of device for preparing and dispensing a prepared beverage have been suggested. Some of these operate with the use of single-serve capsules, containing sufficient material to prepare a single beverage serving.

In the majority of cases these capsules contain particulate beverage infusion material which can produce a beverage when brought into contact with hot water, such as coffee, cocoa, tea.

In a common arrangement of apparatus, heated water is injected into the capsule so that infusion occurs within the capsule and a prepared beverage exits the capsule for dispensing to the user.

In another type of apparatus, contained particulate material leaves the capsule before preparing the beverage in a separate brewing chamber.

WO2007/042485 discloses a device for preparing brewed tea from tea leaves in a single-serve capsule. The capsule provides the filter for preventing spent tea leaves from passing into the prepared beverage from the infusion chamber. Infusion is followed by a rinsing step wherein waste water passes through the capsule to a waste water storage location.

One problem with such machines is that such capsules are difficult to handle and dispose of in an efficient and sustainable manner as they typically contain residues of solids and left-over water from the infusion process.

Other types of machines involve the preparation of a Turkish coffee, wherein the coffee grounds are essentially dissolved or dispersed in the beverage to form a “Turkish or Lebanese” style coffee.

EP 2316312 A discloses a coffee machine wherein a capsule comprising very finely ground coffee is passed through a mechanically complicated electromechanical system which transports the capsule and removes the lid from a capsule of coffee to dispense its contents into a brewing chamber under gravity.

US 2012/0180669 discloses a Turkish coffee machine wherein the coffee is delivered to a brewing chamber from a capsule that is punctured and falls under gravity.

WO 2015/068059 discloses a capsule for preparing a Turkish coffee in a machine. The capsule is remote from the brewing liquid and is ruptured to deliver coffee to a brewing chamber under gravity.

Thus, improvements in this area would be desirable.

### SUMMARY OF INVENTION

In a first aspect, the invention relates to an apparatus for preparing a beverage from a capsule, the capsule comprising particulate beverage precursor material, the apparatus comprising:
(1) a capsule reception location;
(2) a beverage infusion chamber having a chamber inlet for receiving infusion liquid and a chamber outlet comprising a filter for delivering brewed beverage;
(3) an infusion liquid flow path, connecting an infusion liquid supply to a chamber inlet of the infusion chamber;
   characterised in that:
   the capsule reception location is remote from the infusion liquid flow path, and a channel is provided that connects the capsule reception location to the beverage infusion chamber; there also being provided a transport device for transporting the particulate beverage precursor material from the capsule along the channel and to the infusion chamber.

Thus, the apparatus is arranged to deliver the contents of the capsule to an infusion chamber. The capsule is therefore substantially free of any contained particulate material and is therefore in a more clean and convenient condition to be handled and recycled by the user.

The apparatus operates by allowing for a flow of infusion liquid, e.g. water, wherein there is a liquid flow path for transporting the infusion liquid from a source, e.g. a reservoir, to an inlet of the beverage infusion chamber. Furthermore, the capsule reception location is remote from the infusion liquid flow path. This means that the capsule does not come into contact with the infusion liquid. This provides the advantage that the capsule does not interact or come into contact with the infusion liquid, which further assists in keeping disposal of the capsule hygienic and clean.

Typically the infusion liquid will be water, however other infusion liquids may be envisaged. Preferably the infusion liquid supply comprises a reservoir for supplying infusion liquid.

Preferably the infusion liquid flow path comprises a heater to heat infusion liquid, e.g. water, as it travels to the infusion chamber.

The transport device for transporting the particulate beverage precursor material from the capsule along the channel and to the infusion chamber may take a variety of forms. However in a preferred embodiment the transport device comprises (1) a puncturing device for puncturing the capsule to create a capsule inlet into the capsule and a capsule outlet out of the capsule; and (2) a device for directing a flowing gas stream into the capsule through the inlet and out of the capsule through the outlet, so that the particulate beverage precursor material is entrained out of the capsule into the flowing gas stream; and the particulate beverage material being subsequently transported along the channel to deliver the particulate beverage precursor material to the infusion chamber.

Preferably the gas employed to entrain the beverage precursor material from the capsule is air, however other gases may be used to similar effect. The device for directing a flowing gas stream into the capsule may take a variety of forms, however preferably the device comprises a fan.

In a preferred embodiment the infusion chamber outlet has three orientations, (a) a first orientation wherein the outlet is blocked, (b) a second orientation where a channel comprising a filter connects the outlet to a beverage delivery location, and (c) a third orientation where a channel not comprising a filter connects the outlet to a beverage waste location.

This arrangement can be provided by a moveable selector, which can be positioned to (a) block the outlet, (b) connect the outlet to a beverage delivery location and (c) connect the outlet to a beverage waste location.

In a preferred embodiment, the outlet to the infusion chamber is located at the lowest position in use. This has the advantage that the outlet can be used to deliver beverage and/or waste using gravity as a driving force.

As discussed above, the capsule is kept away from the infusion liquid in use and therefore there is also preferably provided a separate capsule waste location which remains free of infusion liquid in use. This keeps the capsule waste location hygienic and convenient to store a number of spent capsules before disposal, e.g. by recycling. Preferably the capsule waste location also remains free of spent particulate beverage material.

It is also preferred that the beverage waste location comprises a chamber having a base and side walls with an upper region and a lower region separated by a filter. This has the effect that the waste water passes through the filter whilst the particulate beverage material is kept on top of the filter. This separation assists further with cleaning and removal of waste by a user.

In a second aspect, the invention relates to a process of preparing a beverage by operating an apparatus according to any one of the preceding claims, the process involving the steps of:
(1) arranging for a capsule to be located at the capsule reception location;
(2) delivering infusion liquid and particulate beverage precursor material to the infusion chamber and preparing a brewed beverage therefrom;
(3) delivering the brewed beverage through the outlet of the infusion chamber;
(4) carrying out a rinsing step wherein infusion liquid is directed inside the infusion chamber.

As discussed above, the apparatus is primarily intended for delivery of a single portion of beverage. As such each capsule generally contains sufficient particulate material for form a single portion of beverage. Thus the internal volume of the capsule is preferably from 10 to 24 cm³.

Thus preferably the volume of infusion liquid, e.g. water, delivered to the infusion chamber in a single infusion is from 150 to 300 ml.

The particulate beverage precursor material may be any infusible or soluble material for preparing a beverage such as dried plant material such as tea particles, coffee particles, cocoa, milk powder and the like. Preferably the particulate beverage precursor material comprises dried plant material, preferably tea particles.

The particulate beverage precursor material preferably has a size (i.e. longest diameter) of from 2 to 10 mm, preferably from 3 to 7 mm. In particular, at least 75%, preferably at least 90% by weight of the particulate beverage precursor material have a size of from 2 to 10 mm, preferably from 3 to 7 mm.

The invention will now be illustrated with reference to the following figures, in which:

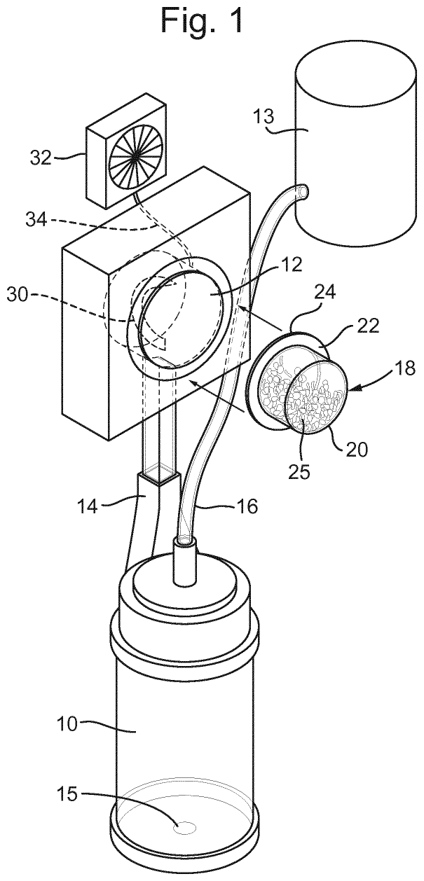

FIG. 1 is a view of an internal group of components for use in a beverage machine.

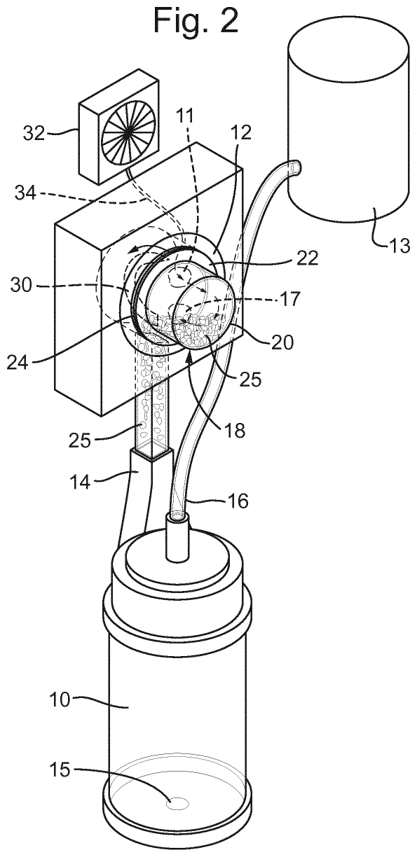

FIG. 2 is a view of the internal group showing the capsule pierced and air blowing the tea particles out of the capsule to the infusion chamber.

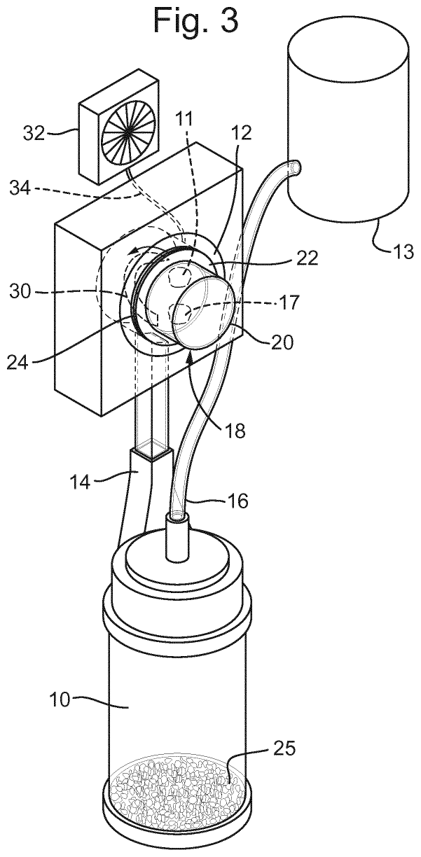

FIG. 3 is a view of the internal group of components after the particulate material has been delivered to the infusion chamber.

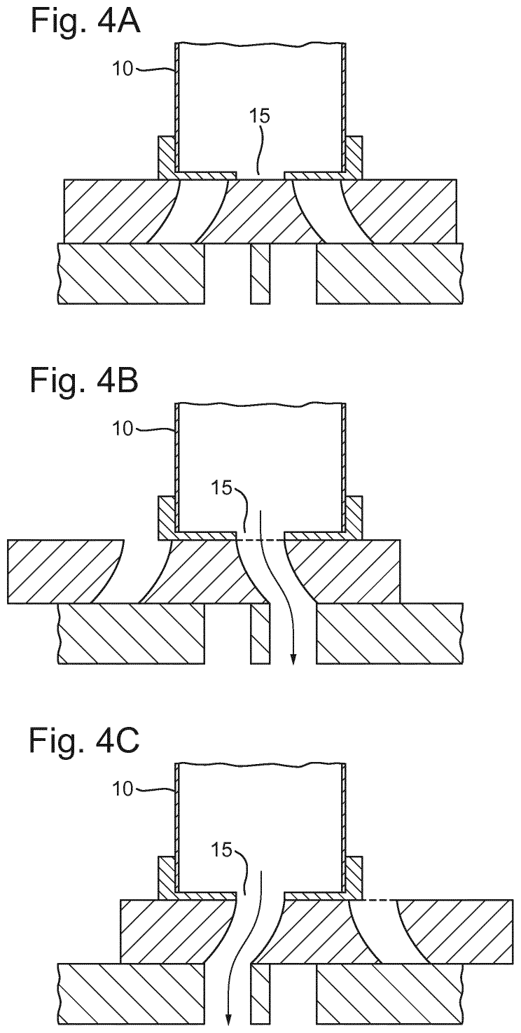

FIG. 4 is a side sectional view of the infusion chamber and the arrangement of the outlet thereof.

Turning to the figures, FIG. 1 shows a group of internal components for use in a beverage machine. The group comprises an infusion chamber 10, a capsule reception location 12, and a channel 14 connecting the capsule reception location 12 with the infusion chamber 10. There is also provided a water reservoir 13 and a water inlet conduit 16 for delivering water from the reservoir to the infusion chamber 10. Although not shown in the figures, the conduit 16 could comprise a water heater, such as an in-line water heater, or the water in the reservoir could be heated. The infusion chamber has a filtered outlet 15, actuatable to deliver a brewed beverage from the infusion chamber 10, and will be discussed in greater detail below.

As can be seen, the capsule 18 is remote from the infusion liquid flow path 13, 16, 10.

The apparatus further comprises an arcuate piercer 30 arranged to rotate about a horizontal axis. An air fan 32 is provided together with a conduit 34 for transporting a flowing stream of air from the fan 32 to the capsule reception location 12.

A capsule 18 is also shown before arriving at the capsule reception location 12.

The capsule comprises a transparent plastic body 20 having a rim 22 and covered in a foil lid 24. The capsule contains tea particles 25, loosely contained within the capsule 18.

In use, the capsule is inserted into the beverage machine and it is directed towards the capsule reception location 12.

As best seen in FIG. 2, once in place at the capsule reception location 12 the apparatus rotates the arcuate piercer 30 so that it punctures the foil lid 24 of the capsule 18 to form an inlet 11 into the capsule at an upper region of the lid 24. As the arcuate piercer 30 continues to rotate, the piercer 30 travels within the body of the capsule and punctures the foil lid 24 again as it rotates further, forming an outlet 17 from the capsule in a lower region of the foil lid 24 by exiting the lid 24 from the inside of the capsule. Once formed the rotational movement of the piercer is reversed to withdraw the piercer 30 to its starting position.

After the inlet 11 and outlet 17 have been formed, the apparatus then engages the air fan 32 which directs a stream of air along conduit 34 into the inlet 11. Air thus flows inside the capsule 18 and is forced out of the capsule via outlet 17. As a result of the flow of air within the capsule, the tea particles become entrained in the stream of air and are dragged out of the capsule 18 along with the air stream out of outlet 17. The air stream and the entrained tea particles then pass down channel 14, as can be seen in FIG. 3.

The tea particles 25 then pass into infusion chamber 10 whereupon the air fan 32 is stopped.

FIGS. 4A to 4C show a side sectional view of the detail of the arrangement of the outlet 15 of the infusion chamber 10. Shown is base 40 which comprises two channels, a first channel 42 leading to a beverage delivery point, and a second channel 44 leading to a beverage waste region. Positioned between the block 40 and the infusion chamber 10 is a moveable selector 46 which comprises two channels, a first channel 30 and a second channel 50. Second channel 50 has a filter 36 positioned at its uppermost region.

FIGS. 4A to 4C show three possible states that the outlet 15 can be in. Initially the outlet is in the state shown in FIG. 4A, wherein the outlet 15 is blocked by moveable selector 46 and neither of channels 42, 44 communicate with channels 48, 50. This prevents any particulates from leaving the infusion chamber 10.

Whilst the outlet 15 remains blocked, heated water from a reservoir 13 is then passed through inlet 16 to the infusion chamber, whereupon the tea particles 25 are infused to form a beverage.

Once the beverage has been formed, the selector 46 is moved to the position shown in FIG. 4B, aligning channel 48 with both the outlet 15 and channel 42 to allow the beverage to be dispensed through dispensing channel 42 for consumption. As the channel 48 comprises a filter 36 at the uppermost end, the particulate material remains in the infusion chamber 10.

Once the beverage has been dispensed, the selector 46 is moved to the position shown in FIG. 4A once again to block the outlet 15. This time infusion liquid, which may not be heated, is introduced into the infusion chamber to act as a rinse.

Once sufficient rinse water has built up in the infusion chamber 10 the selector 46 is moved to the position shown in FIG. 4C aligning channel 50 with both the outlet 15 and the waste channel 44. This has the effect of the rinse water and particulate material to flow out of waste channel 34 to a waste container (not shown).

The capsule 18 is then ejected to a separate waste compartment, which only contains dry, empty capsules, which can easily be emptied to provide a clean and hygienic disposal of the capsules.

1. An apparatus for preparing a beverage from a capsule containing particulate beverage precursor material, the apparatus comprising:
a capsule reception location configured to receive the capsule;
a beverage infusion chamber having a chamber inlet for receiving infusion liquid and a chamber outlet comprising a filter for delivering a brewed beverage;
an infusion liquid supply configured to store the infusion liquid;
an infusion liquid flow path connecting the infusion liquid supply to the chamber inlet of the beverage infusion chamber;
a channel connecting the capsule reception location and the beverage infusion chamber; and
a transport device configured to transport the particulate beverage precursor material from the capsule along the channel and to the beverage infusion chamber;
wherein the capsule reception location is remote from the infusion liquid flow path.

2. The apparatus of claim 1, wherein the infusion liquid supply comprises a reservoir for storing the infusion liquid.

3. The apparatus of claim 1, wherein the chamber outlet has a first orientation where the chamber outlet is blocked and not capable of dispensing the brewed beverage, a second orientation where the chamber outlet is open and capable of dispensing the brewed beverage through the filter, and a third orientation where the chamber outlet is open and capable of dispensing the brewed beverage without the brewed beverage being dispensed through the filter.

4. The apparatus of claim 3, further comprising a moveable selector configured to be positioned to cause the chamber outlet to be in one of the first orientation, the second orientation, or the third orientation;
wherein the chamber outlet is connected to a beverage delivery channel in the second orientation; and
wherein the chamber outlet is connected to a beverage waste location in the third orientation.

5. The apparatus of claim 1, wherein the transport device comprises:
a puncturing device configured to puncture the capsule to create a capsule inlet into the capsule and a capsule outlet out of the capsule; and
a device for directing a flowing gas stream into the capsule through the inlet and out of the capsule through the outlet, so that the particulate beverage precursor material is entrained out of the capsule into the flowing gas stream and the particulate beverage material is subsequently transported along the channel to deliver the particulate beverage precursor material to the beverage infusion chamber.

6. The apparatus of claim 1, wherein the chamber outlet is located at the lowest position in the beverage infusion chamber in use.

7. The apparatus of claim 1, further comprising a separate capsule waste location configured to be isolated from the infusion liquid.

8. The apparatus of claim 1, further comprising a beverage waste location comprising a chamber having a base and side walls with an upper region and a lower region separated by a filter.

9. The apparatus of claim 1, wherein the beverage infusion chamber is configured to receive a volume of the infusion liquid of between 150 ml and 300 ml, inclusive.

10. The apparatus of claim 1, wherein the capsule reception location is configured to receive capsules with an internal volume of between 10 cubic centimeters and 24 cubic centimeters, inclusive.

11. The apparatus of claim 1, wherein the particulate beverage precursor material comprises dried plant material.

12. A process of preparing a beverage by operating an apparatus having a capsule reception location, a beverage infusion chamber having a chamber outlet, a channel connecting the capsule reception location and the beverage infusion chamber, a puncturing device, and a device for directing a flowing gas stream into the capsule, the process comprising:
arranging for a capsule to be located at the capsule reception location;
delivering infusion liquid and particulate beverage precursor material to the beverage infusion chamber and preparing a brewed beverage therefrom;
delivering the brewed beverage through the chamber outlet of the beverage infusion chamber; and
delivering the infusion liquid into the beverage infusion chamber to cause rinsing of the beverage infusion chamber.

13. The process of claim 12, further comprising:
prior to delivering the infusion liquid and particulate beverage precursor material to the beverage infusion chamber, positioning the chamber outlet in a first orientation associated with preventing the brewed beverage from being delivered from the beverage infusion chamber;
prior to delivering the brewed beverage through the chamber outlet, positioning the chamber outlet in a second orientation associated with facilitating delivering of the brewed beverage from the beverage infusion chamber; and
prior to delivering the infusion liquid into the beverage infusion chamber to cause rinsing of the beverage infusion chamber, positioning the chamber outlet in a third orientation associated with facilitating delivering of the infusion liquid from the beverage infusion chamber.

14. The process of claim 13, further comprising prior to positioning the chamber outlet in the third orientation, positioning the outlet in the first orientation.
